(19) United States
(12) Patent Application Publication
(10) Pub. No.: US 2006/0181890 A1
(43) Pub. Date: Aug. 17, 2006

(54) Signalling device for the collision prevention

(76) Inventor: Serge de Tavernier, Carpentras (FR)

Correspondence Address: Serge de Tavernier, 69, rue Jules Ferry, Carpentras, 84200, FR

(21) Appl. No.: 10/509,632

(22) PCT Filed: Apr. 2, 2003
(86) PCT No.: PCT/FR03/01041

§ 371 Date: Sep. 27, 2004

(30) Foreign Application Priority Data
Apr. 4, 2002 (FR) 02/04191

(51) Int. Cl. B60Q 1/10

(52) U.S. Cl. 362/466

(57) ABSTRACT

The invention concerns a signaling device for collision prevention designed to be mounted on the front of a vehicle, said device comprising in at least one housing (B1, B2) a plurality of forward-emitting light sources (D1, D2, D3, D4, D5, D6). Moreover, the light sources are arranged such that their axes gradually diverge from the vehicle axis, so as to create a scrolling effect when the vehicle approaches an observer.

The present invention relates to a light signaling device for the prevention of collisions between vehicles, mainly with two wheels vehicles.

Collisions are often caused by a vehicle driver's misjudgement of the distance and motion of an other vehicle. This estimation is particularly difficult in the case of two wheels vehicles for three main reasons.

In the first place, the front section of a two wheels vehicle is smaller than that of other vehicles, giving thus the impression,of a distance greater than real and making its axis and speed estimation more difficult for other vehicles, because dimensions and perspective variations are here involving a vehicle that is two, perhaps three times narrower than four wheels vehicles.

In the second place, two wheels vehicles single or double headlamps, turned on day and night, provide only a vague indication of their distance and approaching speed, therefore of their path. This lighting can even interfere with their path and position estimation, because of dazzle or of the contrast between high light from the headlamp and the two wheels vehicle and his driver's dark silhouette.

In the third place, the speed variation of two wheels vehicles, which is often larger than other vehicles around them, adds a source of misjudgement to both above mentioned causes.

The device according to the invention improves, on all three above mentioned points, the spatial perception of vehicles, mainly of two wheels vehicles.

According to the invention, a signaling device is provided for mounting on the front of a vehicle, said device comprising, in at least one casing, a plurality of light sources oriented to the front; more, these light sources are thus positioned that their axes diverge gradually off the axis of the vehicle, in such a manner that they create a scrolling effect when the vehicle approaches an observer.

Preferably, the device includes means of modulation to modify the light intensity emitted by at least one of said light sources.

According to a first option, said means of modulation are controlled by the turn signal module of the vehicle.

According to a second option, said means of modulation are controlled by the speed of the vehicle.

According to a third option, said means of modulation are controlled by the rotation speed of the vehicle engine.

Advantageously, the device includes means to reduce the highest modulation frequency to a value that is compatible with the perception of human eye.

According to an additional characteristic of the device, its light sources are designed to emit narrow light beams.

Furthermore, the casing features a transparent front face that concentrates the light sources rays.

In addition, the device includes a light indicator to signal a dysfunction of said device.

One can imagine that the device includes means to modify the light sources highest intensity with the help of an ambient luminosity sensitive sensor C.

One can also imagine that the device includes means to turn on the light sources when the vehicle parking lights are turned on.

The invention applies as well to a vehicle equipped with a lighting module comprising at least one headlamp as well as a device such that defined above; in that configuration, the distance between the light sources is greater than the overall width of said lighting module.

In a preferred embodiment, outermost side parts of the vehicle are fitted with at least some of said light sources oriented sideways and possibly mounted so as to form different angles with the sides of the vehicle so as to insure its sideways signaling during its changes of direction, particularly in traffic circles (roundabouts) and in crossroads.

As mentioned earlier, the invention is particularly well adapted to two wheels vehicles.

The present invention will appear now with more details in the following description of embodiment examples, given as an illustration, by referring to joined figures representing:

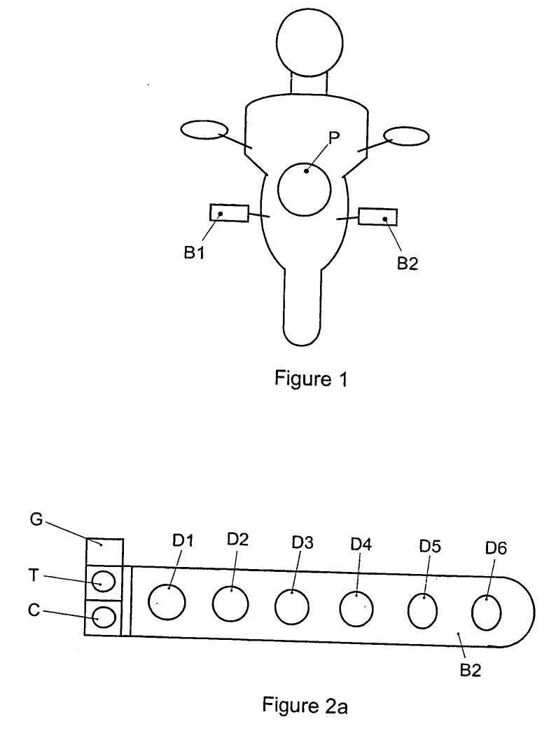

FIG. 1, a front view of a two wheels vehicle equipped with a device according to the invention, and

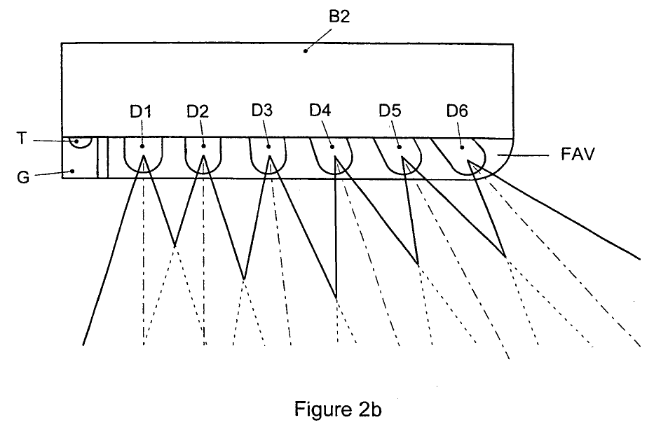

FIGS. 2a, 2b, a front, respectively top view of such a device.

Common elements to several figures are allocated a single and same reference number.

In reference to FIG. 1, the device according to the invention includes one to three casings. In the present case, each of both casings B1 and B2 include light sources that emit narrow beams of high intensity light. These casings are here mounted on either side of a motorcycle fairing, on the front of said fairing.

Very generally, a vehicle is provided with a lighting module. For a car, this module consists of at least two headlamps, said headlamps being located on the outer side of the radiator grille. For a motorcycle, this module is reduced to one single headlamp or two paired headlamps.

The width of the lighting unit of the device according to the invention, or the distance between casings B1, B2, is larger than the lighting module width, headlamp P in the present case, which improves the precision in evaluating the distance and speed of this vehicle.

In reference to FIG. 2, the high directivity of the device light beams results in a noticeable reduction of the beams light intensity when the device path diverges from an observer.

Indeed, the B2 casing includes a plurality of horizontally laid out light sources, six of them, D1, D2, D3, D4, D5, D6 in the present case. Of course, without changing the nature of the present invention, the number of light sources could be different and said light sources could have been differently laid out, for instance in several parallel rows.

From this point of the description on, any of these sources axis will be considered as the axis of its light beam.

The perception of the vehicle path is strengthened by the light sources being laid out on gradually diverging angles off the vehicle axis, consequently producing a lateral scrolling effect of the device.

The device light sources can emit a constant or a modulated light intensity, said modulation following a variable or a permanent pattern, with or without complete extinction phase.

Possibly, one, another or the totality of the light sources can be controlled by the turn indicators module. Preferably, the variable modulation is controlled on the device by the vehicle speed or by the rotation speed of its engine, as to give other drivers an information about the vehicle speed, acceleration or slowing down, and to capture attention by its variable character.

The frequency of the light variation or modulation is controlled by a signal either existing on the vehicle or provided to the device by a specific electromagnetic or other sensor, that can detect an existing signal on the vehicle. The highest value of this frequency is given by an electronic circuit board as to a perceptible value by the human eye, of about 25 Hz to 50 Hz for instance.

The shape of the signal piloting the variable or blinking light sources power feed is provided by an electronic circuit board allowing the selection of the light variation.

To achieve this, one can use an existing signal on the vehicle:

a by-pass leads to the device the electrical signal transmitted to an instrument of the vehicle (rev dial or speedometer) with a Y connection;

detection with help of an electromagnetic sensor, a Hall sensor or other, of the signal present on a electric wire of the vehicle and directed towards an instrument (rev dial or speedometer).

One can also use a signal provided by an accessory specific to the invention:

modulation of the light sources power relating to the speed of the vehicle, the signal being provided by an electromagnetic, optic or other sensor, detecting the speed of rotation of a wheel or of an other element between the exit of the gearbox and a wheel;

modulation of the light sources power relating to the engine rotation speed, the signal being provided by an electromagnetic sensor or other, located for instance on a sparkplug wire.

More, the device function can be subdued to the parking lights by a by-pass, by an optical or electromagnetic sensor, or by any other appropriated means.

The following embodiment refers to the fix light version of the device according to the invention. In this version, the device is fed by the wire feeding the parking lights.

A by-pass (Y connection) is installed on the parking lights feeding wire. According to the type of light sources, the wire of the by-pass is connected to a voltage regulator that provides from the vehicle 12 Volts circuit a stabilized voltage suiting the light sources. The plus and the ground exiting the voltage stabilizer are respectively connected to the + and − tracks of a printed circuit board. These tracks are drilled to allow mounting of the light sources pins, said light sources being here ultra bright Light Emitting Diodes (LED's). Said LED's lenses can be fastened in a to the appropriate diameter pre-drilled board. The diodes pins are soldered on the printed circuit board.

The circuit board and the LED's are mounted in the waterproof B2 casing made of two parts. The rear part of the casing can be opaque while the front part FAV has to be transparent.

The LED's emit a concentrated light beam (about 8° wide) making lenses redundant on the transparent face, but lenses can be necessary to obtain sufficiently narrow beams if one uses an other type of light sources such as filament bulbs or other light sources based on a different technology such as neon tubes or otherwise fluorescent light sources.

The device according to the invention can be provided with a light indicator T that is turned on to indicate a device dysfunction. When this indicator is located on the front face of the B2 casing, a prism will be integrated to reflect a part of the light emitted by the luminous indicator T into the driver's field of vision, informing thus the driver of the dysfunction. On the contrary, this indicator could be turned on while the device is functioning properly and turned off in case of dysfunction.

Independently of the earlier described time-based light intensity modulation of the light sources, the device according to the invention can be provided with a light-sensitive sensor C allowing to modify the highest intensity emitted by these sources according to the ambient luminosity, so as to not to disturb other drivers. Thus, in daylight, light sources are fed with maximum power, while this level is noticeably reduced at night. More, the sensor C is oriented towards the front of the vehicle, so as, if said sensor detects headlamps of an other vehicle coming to its encounter, to increase the device electrical power supply to the light sources.

The device casings can be fastened on a bracket, on the mirrors front faces, inside or outside the turn signal indicators, on the vehicle body or on any other location indicated by the configuration and the type-approval of the vehicle.

The device can also include side parts, possibly connected to above described casings, oriented to the sides of the vehicle. Said side parts can contain several light sources oriented on progressive angles as compared to the axis of the vehicle, so as to emit a visible light in situations where the paths of two vehicles form an angle larger than the visibility angle of the device seen from the front. These situations occur for example in traffic circles or approaching crossroads.

Furthermore, the light sources can be assembled on one or several bars and share a common or separate electricity supplies in order to produce luminous effects such as a scrolling light.

Embodiment examples of the invention have been chosen for their specific characters. It is, however, impossible to give an exhaustive list of all embodiments covered by this invention. Particularly, any described means can be replaced by an equivalent means without leaving the background of the present invention.

1) Signaling device for collision prevention aimed for installation on the front of a vehicle, said device including at least one casing B1, B2, a plurality of light sources D1, D2, D3, D4, D5, D6 oriented towards the front,
characterized herein that said light sources are thus positioned that their axes diverge gradually from the axis of the vehicle, in such a way as to create a scrolling effect when the vehicle approaches an observer, said device featuring means of modulation controlled by the vehicle engine rotation speed to modify the light intensity produced by at least one of said light sources D1, D2, D3, D4, D5, D6.

2) Device according to claim 1, characterized herein that it includes means to reduce the highest modulation frequency to a value that is compatible with the perception of human eye.

3) Device according to any preceding claim, characterized herein that it includes means to modify the highest light intensity produced by said light sources D1, D2, D3, D4, D5, D6 using a light-sensitive sensor C, said sensor being sensitive to ambient luminosity.

4) Device according to any preceding claim, characterized herein that said light sources D1, D2, D3, D4, D5, D6 are designed to emit narrow light beams.

5) Device according to any preceding claim, characterized herein that said casing B1, B2 includes a transparent front face FAV that concentrates the light rays of said light sources D1, D2, D3, D4, D5, D6.

6) Device according to any preceding claim, characterized herein that it includes a luminous indicator T to signal a dysfunction of said device.

7) Device according to any preceding claim, characterized herein that said means of modulation are controlled by the turn signal module of the vehicle.

8) Device according to any preceding claim, characterized herein that it includes means to turn on said light sources D1, D2, D3, D4, D5, D6 when the vehicle parking lights are turned on.

9) Vehicle featuring a lighting module including at least one headlamp P, including as well a device according to any preceding claim, characterized herein that the distance between said light sources D1, D2, D3, D4, D5, D6 is larger than the width of said lighting module P.

10) Vehicle according to the preceding claim, characterized herein that its parts located on the sides include at least some said light sources oriented sideways, possibly at different angles to the vehicle sides so as to insure its sideways/front signaling during said vehicle changes of direction, notably in traffic circles and in crossroads.

11) Vehicle according to any of claims 9 or 10, characterized herein that it includes two wheels only.
